(19) United States
(12) Patent Application Publication
(10) Pub. No.: US 2013/0306113 A1
(43) Pub. Date: Nov. 21, 2013

(54) CLEANING APPARATUS AND METHOD

(71) Applicant: Carts & Parts, Inc., Oklahoma City, OK (US)

(72) Inventors: Robert S. Weiss, Oklahoma City, OK (US); Daryl Gillit, San Antonio, TX (US); Jake Gillit, San Antonio, TX (US)

(73) Assignee: Carts & Parts, Inc., Oklahoma City, OK (US)

(21) Appl. No.: 13/874,120

(22) Filed: Apr. 30, 2013

Related U.S. Application Data
(60) Provisional application No. 61/640,521, filed on Apr. 30, 2012.
(60) Provisional application No. 61/793,608, filed on Mar. 15, 2013.

(51) Int. Cl. B08B 3/02

(52) U.S. Cl. CPC B08B 3/02
USPC 134/36; 134/102.2

(57) ABSTRACT

An apparatus and method for cleaning a surface comprising a gas dispensing conduit having a first end connectable to a source of pressurized gas and an open second end such that a stream of pressurized gas may be dispensed from the open second end of the gas dispensing conduit. A liquid dispensing conduit is connectable to a source of liquid and associated with the gas dispensing conduit in such a way that liquid is introduced into the stream of pressurized gas wherein the liquid dispensing conduit allows liquid to be introduced into the stream of pressurized gas at a rate that causes the liquid to contact the surface to be cleaned while substantially preventing the liquid from running off the surface.

### INCORPORATION BY REFERENCE

The entirety of U.S. Provisional Application Ser. No. 61/640,521, filed on Apr. 30, 2012, and U.S. Provisional Application Ser. No. 61/793,608, filed on Mar. 15, 2013, are each hereby expressly incorporated herein by reference.

### BACKGROUND

Cleaning systems come in a variety of configurations depending on the environment. For example, for exterior surfaces, pressure washers are often used. Pressure washers may propel either cold or hot water at high pressures of around 150-500 psi to 3000 psi. While pressure washers are generally effective for cleaning surfaces, they can consume in excess of 250 gallons of water per hour. Due to their excessive water consumption, these pressure washers are not practical to use at remote locations where water sources are not readily available or at locations where excessive runoff is created, such in parking lots. Further, if chemicals are used, the effluent may be required to be removed to ensure compliance with environmental regulations.

Other known cleaning systems include high pressure steam machines that also use an excess amount of water similar to high-pressure washers. These types of machines can clean and assist in disinfecting objects and surfaces since they produce steam at high temperatures up to about 250° F. However, this technology is highly inefficient since an abundance of energy is required to heat 3 or 4 gallons of water per minute to 212° F. to 250° F.

Although other systems, including low pressure steam machines have been attempted, these machines, while providing some disinfecting ability, often lack abrasive force due to their low-pressure output. Further, machines intended for domestic use, generally lack the ability to continuously feed water into a boiler; this means, as the boiler capacity is quite small, that the user cannot operate the machine for more than a few minutes, and then must wait until the boiler has sufficiently cooled before replenishing the boiler with water.

### BRIEF DESCRIPTION OF THE DRAWINGS

FIG. 1 is a schematic illustration of a cleaning apparatus constructed in accordance with the inventive concepts disclosed herein.

FIG. 2 is a schematic illustration of a gas dispensing conduit and a liquid dispensing conduit.

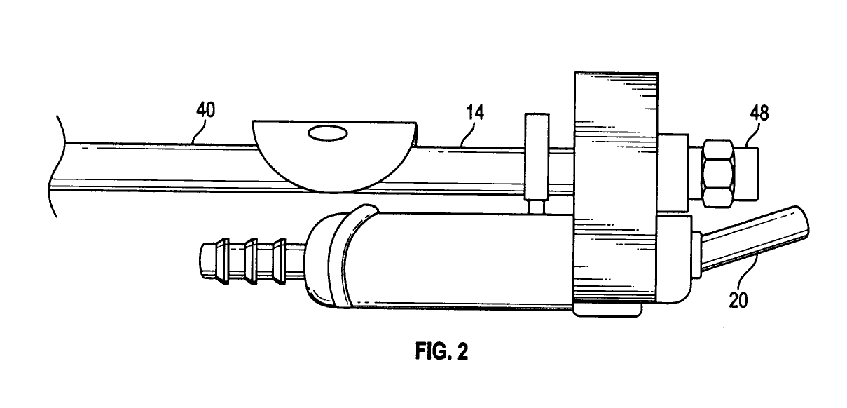

FIG. 3 is a schematic illustration of another embodiment of a cleaning apparatus constructed in accordance with the inventive concepts disclosed herein.

FIG. 4 is a schematic illustration of another embodiment of a cleaning apparatus constructed in accordance with the inventive concepts disclosed herein.

FIG. 5 is a schematic illustration of an exemplary embodiment of a wand assembly according to the inventive concepts disclosed herein.

### DETAILED DESCRIPTION OF EXEMPLARY EMBODIMENTS

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

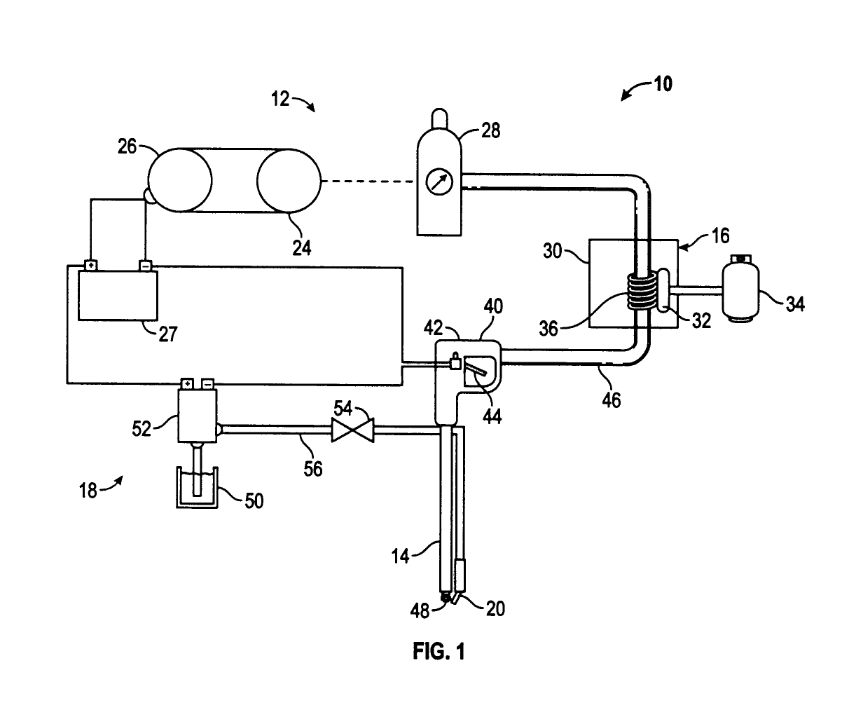

Referring now to FIG. 1, an exemplary embodiment of a cleaning apparatus 10 constructed in accordance with the inventive concepts disclosed herein is schematically illustrated. The cleaning apparatus 10 may include a source of pressurized gas 12, a gas dispensing conduit nozzle 14, a heater assembly 16, a source of liquid 18, and a liquid dispensing conduit 20. The gas dispensing conduit 14 is in fluid communication with the source of pressurized gas 12 such that a stream of pressurized gas may be dispensed from the gas dispensing conduit 14. The heater assembly 16 is interposed between the source of pressurized gas 12 and the gas dispensing conduit 14 such that the stream of pressurized gas dispensed from the gas dispensing conduit 14 may be heated to a temperature greater than ambient temperature. The liquid dispensing conduit 20 is in fluid communication with the source of liquid 18 and associated with the gas dispensing conduit 14 in such a way that an amount of liquid is injected into the stream of heated, pressurized gas downstream of the gas dispensing conduit 14.

The cleaning apparatus 10 is constructed to effectively clean a variety of surfaces and structures while utilizing a low volume of water. The cleaning apparatus 10 can produce a heated, pressured gas stream (e.g., air) combined with a low volume of liquid (e.g., water), providing abrasive power for effective cleaning. The liquid dispensing conduit 20 allows liquid to be introduced into the stream of pressurized gas at a rate that causes the liquid to contact the surface to be cleaned while substantially preventing the liquid from running off the surface. In one embodiment, the liquid dispensing conduit 20 is configured to introduce liquid into the stream of pressurized gas at a liquid-to-gas ratio in a range from about 0.5 ml to about 2 ml per one cubic foot of pressurized gas when the stream of pressurized gas is dispensed from the gas dispensing conduit 14 at a pressure in a range from about 80 psi to about 150 psi and at a flow rate in a range from about 125 cfm to about 400 cfm. The stream of pressured gas generated by the cleaning apparatus 10 may be heated to a temperature in a range from about 150° F. to about 250° F.

The cleaning apparatus 10 may be provided with a support structure, which may be in the form of a frame, skid, cart (portable), housing, or the like. The cleaning apparatus 10 may be provided in many different configurations, or integrated into other equipment or vehicles, as will hereafter be described in more detail.

The source of pressured gas 12 may include a compressor 24, an engine 26 for driving the compressor 24, a battery 27 for energizing the engine 26, a gas storage vessel 28, and a conduit 29 extending between the compressor 24 and the gas storage vessel 28.

The heater assembly 16 may include a housing 30, a burner assembly 32, and a fuel source 34. The fuel source may be any suitable fuel source, such as liquid petroleum gas (e.g., propane). The heater assembly 16 further includes a coil 36 housed in the housing 30. The coil 36 is fluidly interposed between the gas storage vessel 28 and the gas dispensing conduit 14. The coil 36 and the burner assembly 32 are operated in such a manner that the gas passing through the coil 36 is heated to a temperature in a range from about 150° F. to about 250° F.

The gas dispensing conduit 14 may be in a variety of forms. One exemplary form is that the gas dispensing conduit 14 is provided as a wand assembly 40 having a handle 42 and a trigger assembly 44 for selectively controlling dispersion of air from the gas dispensing conduit 14. The wand assembly 40 may be operably connected to the coil 36 with a conduit 46. In one embodiment, the gas dispensing conduit 14 may include a nozzle 48, such as a 15 degree pressure washer spray tip.

The source of liquid 18 includes a liquid storage reservoir 50. Because the cleaning apparatus 10 is intended to use a low volume of liquid, the liquid storage reservoir 50 may have a volume of about five gallons. A conduit 56 is provided between the liquid storage reservoir 50 and the liquid dispensing conduit 20. In one embodiment, liquid may be drawn into the stream of pressurized gas dispensed from the gas dispensing conduit 14 by a Venturi effect. Alternatively, the liquid storage reservoir 50 may be pressurized, or the pump 52, which is interposed between the liquid storage reservoir 50 and the liquid dispensing conduit 20, may be used to inject a liquid into the stream of heated gas. To control the volume and rate at which the liquid is dispensed, a regulating valve 54 may be interposed between the liquid storage reservoir 50 and the open end of the liquid dispensing conduit 20.

The liquid dispensing conduit 20 may be positioned adjacent the gas dispensing conduit 14 and angularly disposed relative to an axis of the gas dispensing conduit 14 such that the liquid dispensed from the liquid dispensing conduit 20 is injected into the stream of pressurized gas dispensed from the gas dispensing conduit 14. By way of example, the liquid dispensing conduit 20 may be disposed at an angle relative to the stream of heated gas in a range from about 30 degrees to about 50 degrees.

The cleaning apparatus 10 may be used to clean a surface in a manner similar to a spray washer. While the cleaning apparatus 10 has been described primarily as using air and water, it will be appreciated that the cleaning apparatus 10 may be used with any suitable gas and any suitable liquid or combination of liquids. For example, the liquid may include selected solvents such as surfactants and degreasers, if desired.

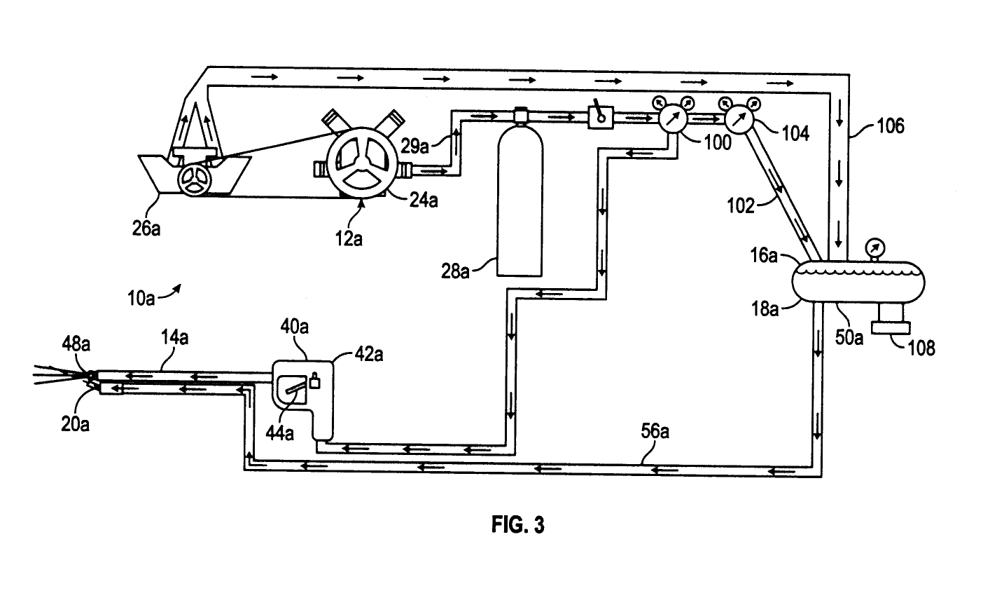

Referring now to FIG. 3, another embodiment of a cleaning apparatus 10a is illustrated. The cleaning apparatus 10a may include a source of pressurized gas 12a, a gas dispensing conduit 14a, a heat exchange assembly 16a, a source of liquid 18a, and a liquid dispensing conduit 20a. The gas dispensing conduit 14a is in fluid communication with the source of pressurized gas 12a such that a stream of pressurized gas may be dispensed from the gas dispensing conduit 14a. The liquid dispensing conduit 20a is in fluid communication with the source of liquid 18a and is associated with the gas dispensing conduit 14a in such a way that an amount of liquid is injected into the stream of pressurized gas downstream of the gas dispensing conduit 14a. The heat exchange assembly 16a may be utilized to heat the source of liquid 18a such that the liquid is heated to a desired temperature, such as 200° F.

The cleaning apparatus 10a is constructed to effectively clean a variety of surfaces and structures while utilizing a low volume of water as described above so as to prevent runoff. The cleaning apparatus 10a produces a pressured gas stream (e.g., air), combined with a low volume of liquid (e.g., water) providing abrasive power for effective cleaning. The liquid may be heated to a temperature in a range from about 150° F. to about 200° F.

Like the cleaning apparatus 10, the cleaning apparatus 10a may be provided with a support structure which may be in the form of a frame, skid, cart (portable), housing, or the like. The cleaning apparatus 10a may be provided in many different configurations, or integrated into other equipment or vehicles, for example.

The source of pressured gas 12a may include a compressor 24a, an engine 26a for driving the compressor 24a, a gas storage vessel 28a, and a conduit 29a extending between the compressor 24a and the gas storage vessel 28a. The gas dispensing conduit 14a may be in a variety of forms. One exemplary form is that the gas dispensing conduit 14a is provided on a wand assembly 40a having a handle 42a and a trigger assembly 44a for selectively controlling dispersion of air from the gas dispensing conduit 14a. The wand assembly 40a is operably connected to a regulator 100 interposed between the wand assembly 40a and the gas storage vessel 28a. In one embodiment, the gas dispensing conduit 14a may include a nozzle 48a, such as a 15 degree pressure washer spray tip.

The source of liquid 18a includes a liquid storage reservoir 50a. Because the cleaning apparatus 10a is intended to use a low volume of liquid, the liquid storage reservoir 50a may have a volume of about five gallons. However, it should be appreciated that the volume of the liquid storage reservoir 50a may have any capacity. A conduit 56a is provided between the liquid storage reservoir 50a and the liquid dispensing conduit 20a. In one embodiment, liquid may be drawn into the stream of pressurized gas dispensed from the gas dispensing conduit 14a by a Venturi effect. Alternatively, the liquid storage reservoir 50a may be pressurized in any suitable manner. For example, the liquid storage reservoir 50a may be pressurized utilizing pressurized gas provided by the source of pressurized gas 12a. More specifically, a conduit 102 may be connected to the liquid storage reservoir 50a such that pressurized gas pressurizes the liquid storage reservoir 50a. A regulator 104 may be utilized to pressurize the liquid storage reservoir to a desired pressure, such as in a range from about 1 psig to about 5 psig.

The liquid may be heated in any suitable manner. In one embodiment, the liquid storage reservoir 50a may be provided with the heat exchanger assembly 16a such that the exhaust from the engine 26a may be employed to heat the liquid. To this end, a conduit 106 is extended between the exhaust of the engine 26a and the heat exchange assembly 16a. The heat exchange assembly 16a may be any suitable structure for transferring heat of the exhaust of the engine 26a to the liquid contained in the liquid storage reservoir 50a, such as a jacket formed about liquid storage reservoir 50a which receives the exhaust, transfers heat to the liquid, and discharges the exhaust via an muffler 108, by way of example.

The liquid dispensing conduit 20a may be positioned adjacent the gas dispensing conduit 14a and angularly disposed relative to an axis of the gas dispensing conduit 14a such that the liquid dispensed from the liquid dispensing conduit 20a is injected into the stream of gas dispensed from the gas dispensing conduit 14a. By way of example, the liquid dispensing conduit 20a may be disposed at an angle relative to the stream of heated gas in a range from about 30 degrees to about 50 degrees.

Like the cleaning apparatus 10, the cleaning apparatus 10a may be used to clean a surface in a manner similar to a spray. While the cleaning apparatus 10a has been described primarily as using air and water, it will be appreciated that the cleaning apparatus 10a may be used with any suitable gas and any suitable liquid or combination of liquids. For example, the liquid may include selected solvents such as surfactants and degreasers, if desired.

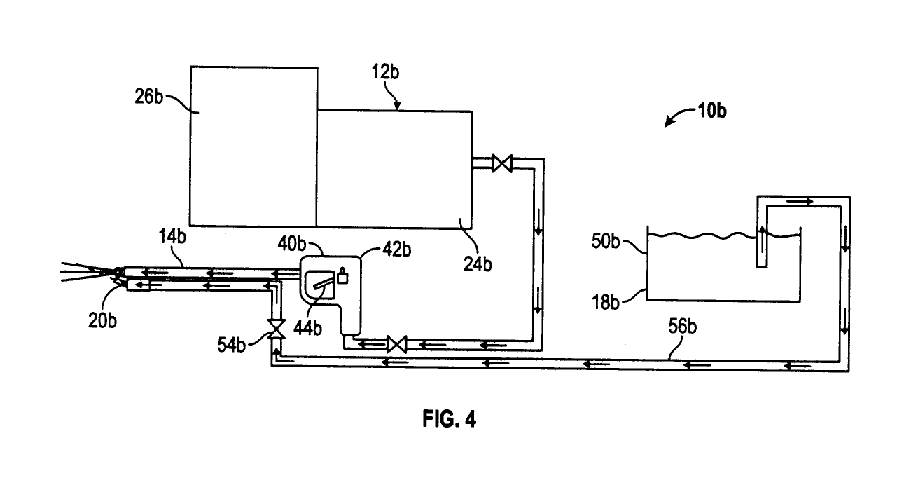

Referring now to FIG. 4, an exemplary embodiment of a cleaning apparatus 10b constructed in accordance with the inventive concepts disclosed herein is schematically illustrated. The cleaning apparatus 10b may include a source of pressurized gas 12b, a gas dispensing conduit 14b, a source of liquid 18b, and a liquid dispensing conduit 20b. The gas dispensing conduit 14b is in fluid communication with the source of pressurized gas 12b such that a stream of gas may be dispensed from the gas dispensing conduit 14b. The liquid dispensing conduit 20b is in fluid communication with the source of liquid 18b and is associated with the gas dispensing conduit 14b in such a way that an amount of liquid is injected into the stream of gas downstream of the gas dispensing conduit 14b.

The cleaning apparatus 10b is constructed to effectively clean a variety of surfaces and structures while utilizing a low volume of water. The cleaning apparatus 10b produces a pressurized gas stream (e.g., air), combined with a low volume of liquid (e.g., water) providing abrasive power for effective cleaning. The stream of pressurized gas generated by the cleaning apparatus 10b may be heated to a temperature greater than ambient temperature and in one embodiment in a range from about 100° F. to about 250° F. at a pressure in a range from about 80 psi to about 150 psi discharged at a flow rate in a range from about 125 cfm to about 400 cfm. The cleaning apparatus 10b is configured to consume liquid at a flow rate in a range from about 0.5 ml to about 2 ml per one cubic foot.

The cleaning apparatus 10b may be provided with a support structure which may be in the form of a frame, skid, cart (portable), housing, or the like. The cleaning apparatus 10b may be provided in many different configurations, or integrated into other equipment or vehicles, for example.

The source of pressured gas 12b may include a compressor 24b, an engine 26b for driving the compressor 24b, and an optional gas storage vessel (not shown). By way of example, the compressor 24b may be a rotary screw compressor. As such, the compressor 24b may generate heat during operation. Such heat may be transferred to the pressurized gas so as to produce a heated pressurized gas. In one embodiment, the pressurized gas is heated to a temperature in a range from about 100° F. to about 250° F.

The gas dispensing conduit 14b may be in a variety of forms. One exemplary form is that the gas dispensing conduit 14b is provided in a wand assembly 40b having a handle 42b and a trigger assembly 44b for selectively controlling dispersion of gas from the gas dispensing conduit 14b.

The source of liquid 18b includes a liquid storage reservoir 50b. Because the cleaning apparatus 10 is intended to use a low volume of liquid, the liquid storage reservoir 50b may have a volume of about five gallons. A conduit 56b is provided between the liquid storage reservoir 50b and the liquid dispensing conduit 20b. In one embodiment, liquid may be drawn into the stream of pressurized gas dispensed from the gas dispensing conduit 14b by a Venturi effect. Alternatively, the liquid storage reservoir 50b may be pressurized or a pump may be employed to inject a liquid into the stream of gas. To control the volume and rate at which the liquid is dispensed, a regulating valve 54b may be interposed between the liquid storage reservoir 50b and the open end of the liquid dispensing conduit 20b.

The liquid dispensing conduit 20b may be positioned adjacent the gas dispensing conduit 14b and angularly disposed relative to an axis of the gas dispensing conduit 14b such that the liquid dispensed from the liquid dispensing conduit 20b is injected into the stream of heated gas dispensed from the gas dispensing conduit 14b. By way of example, the liquid dispensing conduit 20 may be disposed at an angle relative to the stream of gas in a range from about 30 degrees to about 50 degrees.

The cleaning apparatus 10b may be used to clean a surface in a manner similar to a spray washer. While the cleaning apparatus 10b has been described primarily as using air and water, it will be appreciated that the cleaning apparatus 10b may be used with any suitable gas and any suitable liquid or combination of liquids. For example, the liquid may include selected solvents such as surfactants and degreasers, if desired.

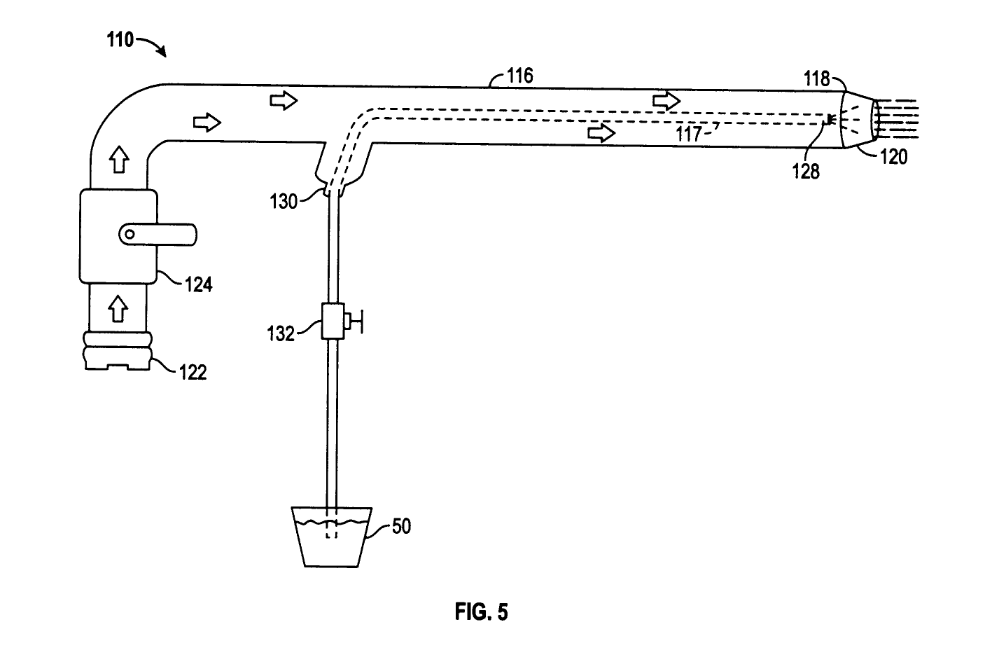

Referring now to FIG. 5, shown therein is an exemplary embodiment of a wand assembly 110. The wand assembly 110 may be implemented and may function similarly to the wand assemblies 40, 40a, and 40b described, as will be appreciated by persons of ordinary skill in the art. The wand assembly 110 includes a gas dispensing conduit 116 and a liquid dispensing conduit 117.

The gas dispensing conduit 116 has an end 118 that may include a nozzle 120. The gas dispensing conduit 116 is configured to be fluidly connected with a source of pressurized gas, such as the gas storage vessel 28 or 28a, for example. A coupling 122 may be implemented to fluidly connect the gas dispensing conduit 116 to the gas storage vessel 28 or 28a. An air valve or a trigger valve 124 may be implemented upstream of the coupling 122, and is configured to selectively open and close so as to allow or prevent pressurized gas from flowing through the gas dispensing conduit 116. The gas dispensing conduit 116 may have any desired size, shape and/or cross-section, provided that the gas dispensing conduit 116 is configured to dispense, emit, eject, or otherwise direct a stream of gas and liquid at a selected pressure and flow rate, as has been described above.

The liquid dispensing conduit 117 is disposed in the gas dispensing conduit 116. More particularly, the liquid dispensing conduit 117 is shown as extending substantially coaxially with the gas dispensing conduit 116 and as terminating with an open end 128 positioned inside the gas dispensing conduit 116 at a distance from the gas dispensing nozzle 120. The liquid dispensing conduit 117 may enter the gas dispensing conduit 116 via a port 130, and is fluidly connectable with a source of liquid, such as the liquid storage reservoir 50, 50a, or 50b described above, for example. A liquid regulating valve 132 may be interposed in the liquid dispensing conduit so that the volume and/or pressure of liquid flowing through the liquid dispensing conduit 117 is adjustable by operating the liquid regulating valve 132.

As will be appreciated by persons of ordinary skill in the art, the liquid dispensing conduit 117 and the liquid injection nozzle 128 are positioned inside the gas dispending conduit 116 so as to prevent backpressure from being exerted on the liquid dispensing conduit 117 by the stream of pressurized gas flowing through the gas dispensing conduit 116 and so that a volume of liquid may be introduced into the stream of pressurized gas stream prior to the stream of pressurized gas being dispensed by the gas dispensing nozzle 120. Such orientation allows the volume of liquid to mix with, or otherwise disperse in the stream of pressurized gas and to be evenly dispersed within the stream of pressurized gas upon discharge from the wand assembly 110.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed herein.

What is claimed is:

1. An apparatus for cleaning a surface, comprising:
a gas dispensing conduit having a first end connectable to a source of pressurized gas and an open second end such that a stream of pressurized gas may be dispensed from the open second end of the gas dispensing conduit; and
a liquid dispensing conduit having a first end and a second end, the first end connectable to a source of liquid and the second end associated with the gas dispensing conduit in such a way that liquid is introduced into the stream of pressurized gas,
wherein the liquid dispensing conduit allows liquid to be introduced into the stream of pressurized gas at a rate that causes the liquid to contact the surface to be cleaned while substantially preventing the liquid from running off the surface.

2. The apparatus of claim 1, wherein the liquid dispensing conduit is configured to introduce liquid into the stream of pressurized gas at a liquid-to-gas ratio in a range from about 0.5 ml to about 2 ml per one cubic foot of pressurized gas when the stream of pressurized gas is dispensed from the open second end of the gas dispensing conduit at a pressure in a range from about 80 psi to about 150 psi and at a flow rate in a range from about 125 cfm to about 400 cfm.

3. The apparatus of claim 3, wherein the liquid dispensing conduit has a valve interposed therein for regulating the rate liquid is introduced into the stream of pressurized gas.

4. The apparatus of claim 1, wherein the second end of the liquid dispensing conduit is positioned downstream of the open second end of the gas dispensing conduit.

5. The apparatus of claim 4, wherein the second end of the liquid dispensing conduit is angularly disposed relative to an axis of the gas dispensing conduit.

6. The apparatus of claim 5, wherein the liquid dispensing conduit is angularly disposed relative to the axis of the gas dispensing conduit at an angle in a range from about 30° degrees to about 50°.

7. The apparatus of claim 1, wherein the second end of the liquid dispensing conduit is positioned in the gas dispensing conduit so that the second end of the liquid dispensing conduit is positioned upstream of the open second end of the gas dispensing conduit.

8. The apparatus of claim 7, wherein the second end of the liquid dispensing conduit is axially aligned with a longitudinal axis of the gas dispensing conduit.

9. An apparatus cleaning a surface, comprising:
a source of pressurized gas;
a gas dispensing conduit having a first end connected to the source of pressurized gas and an open second end such that a stream of pressurized gas may be dispensed from the open second end of the gas dispensing conduit at a pressure in a range from about 80 psi to about 150 psi and at a flow rate in a range from about 125 cfm to about 400 cfm; and
a liquid dispensing conduit having a first end and a second end, the first end connectable to a source of liquid and the second end associated with the gas dispensing conduit in such a way that liquid is introduced into the stream of pressurized gas,
wherein the liquid dispensing conduit allows liquid to be introduced into the gas stream at a rate that causes the liquid to contact the surface to be cleaned while substantially preventing the liquid from running off the surface.

10. The apparatus of claim 9, further comprising a heater assembly interposed between the source of pressurized gas and the second open end of the gas dispensing conduit such that the stream of gas dispensed from the gas dispensing conduit is heated to a temperature in a range from about 150° F. to about 250° F.

11. The apparatus of claim 9, further comprising a heater assembly interposed between the source of liquid and the second end of the liquid dispensing conduit such that the liquid dispensed from the second end of the water dispensing conduit is heated to a temperature in a range from about 150° F. to about 200° F.

12. The apparatus of claim 9, wherein the liquid dispensing conduit is configured to introduce liquid into the stream of gas at a liquid-to-gas ratio in a range from about 0.5 ml to about 2 ml per one cubic foot of pressurized gas.

13. The apparatus of claim 12, wherein the liquid dispensing conduit has a valve interposed therein for regulating the rate liquid is introduced into the stream of gas.

14. The apparatus of claim 9, wherein the second end of the liquid dispensing conduit is positioned downstream of the open second end of the gas dispensing conduit.

15. The apparatus of claim 14, wherein the second end of the liquid dispensing conduit is angularly disposed relative to an axis of the gas dispensing conduit.

16. The apparatus of claim 15, wherein the liquid dispensing conduit is angularly disposed relative to the axis of the gas dispensing conduit at an angle in a range from about 30° degrees to about 50°.

17. The apparatus of claim 9, wherein the second end of the liquid dispensing conduit is positioned in the gas dispensing conduit so that the second end of the second end of the liquid dispensing conduit is positioned upstream of the open second end of the gas dispensing conduit.

18. The apparatus of claim 17, wherein the second end of the liquid dispensing conduit is axially aligned with a longitudinal axis of the gas dispensing conduit.

19. A method of cleaning a surface, comprising:
directing a stream of gas at a surface to be cleaned at a pressure in a range from about 80 psi to about 150 psi at a flow rate in a range from about 125 cfm to about 400 cfm; and
introducing a volume of liquid into the gas stream at a rate that causes the liquid to contact the surface to be cleaned while substantially preventing the liquid from running off the surface.

20. The method of claim 19, wherein the volume of liquid is introduced into the gas stream at a liquid-to-gas ratio ranging of from about 0.5 ml to about 2.0 ml per one cubic foot of pressurized gas.
